(19) United States
(12) Patent Application Publication
(10) Pub. No.: US 2022/0408805 A1
(43) Pub. Date: Dec. 29, 2022

(54) ELECTRONIC AEROSOL PROVISION SYSTEM

(71) Applicant: Nicoventures Trading Limited, London (GB)

(72) Inventors: Jocelyn Benning, London (GB); Kelly Rees, London (GB); Walid Abi Aoun, London (GB)

(21) Appl. No.: 17/780,147

(22) PCT Filed: Nov. 27, 2020
(86) PCT No.: PCT/EP2020/083781

§ 371 Date: May 26, 2022

(30) Foreign Application Priority Data
Nov. 29, 2019 (GB) 1917471.3

(51) Int. Cl. A24F 40/30; A24F 40/46; A24F 40/50

(52) U.S. Cl. CPC A24F 40/30; A24F 40/46; A24F 40/50

(57) ABSTRACT

An aerosol provision device for use with an aerosol generating article including aerosol generating material having one or more aerosol generating components arranged to aerosolize different portions of the aerosol generating material and control circuitry for supplying power to the one or more aerosol generating components, the control circuitry is configured to perform an aerosolization process on a first portion of the aerosol generating material on at least two separate occasions.

### RELATED APPLICATION INFORMATION

The present application is a National Phase entry of PCT Application No. PCT/EP2020/083781, filed Nov. 27, 2020, which claims priority from GB Patent Application No. 1917471.3, filed Nov. 29, 2019, each of which is hereby fully incorporated herein by reference.

### FIELD

The present disclosure relates to non-combustible aerosol provision systems.

### BACKGROUND

Electronic aerosol provision systems such as electronic cigarettes (e-cigarettes) generally contain a reservoir of a source liquid containing a formulation, typically including nicotine, from which an aerosol is generated, e.g. through heat vaporization. An aerosol source for an aerosol provision system may thus comprise a heater having a heating element arranged to receive source liquid from the reservoir, for example through wicking/capillary action. While a user inhales on the device, electrical power is supplied to the heating element to vaporize source liquid in the vicinity of the heating element to generate an aerosol for inhalation by the user. Such devices are usually provided with one or more air inlet holes located away from a mouthpiece end of the system. When a user sucks on a mouthpiece connected to the mouthpiece end of the system, air is drawn in through the inlet holes and past the aerosol source. There is a flow path connecting between the aerosol source and an opening in the mouthpiece so that air drawn past the aerosol source continues along the flow path to the mouthpiece opening, carrying some of the aerosol from the aerosol source with it. The aerosol-carrying air exits the aerosol provision system through the mouthpiece opening for inhalation by the user.

Other aerosol provision devices generate aerosol from a solid material, such as tobacco or a tobacco derivative. Such devices operate in a broadly similar manner to the liquid-based systems described above, in that the solid tobacco material is heated to a vaporization temperature to generate an aerosol which is subsequently inhaled by a user. in some example systems, an entire portion of tobacco material is heated constantly for the duration of a session (i.e., for multiple user inhalations).

When a bulk solid material is heated, this can be an inefficient process both in terms of the energy required to heat the bulk solid material and also the time required for the bulk material to reach an aerosol generation temperature can be quite lengthy.

Various approaches are described which seek to help address some of these issues.

### SUMMAR V

According to a first aspect of certain embodiments there is provided an aerosol provision device for use with an aerosol generating article comprising aerosol generating material, the aerosol provision device comprising: one or more aerosol generating components arranged to aerosolize different portions of the aerosol generating material; and control circuitry for supplying power to the one or more aerosol generating components, wherein the control circuitry is configured to perform an aerosolization process on a first portion of the aerosol generating material on at least two separate occasions.

According to various embodiments the control circuitry may be configured to perform an aerosolization process on a first portion of the aerosol generating, material on at least three, four, five, six, seven, eight, nine, ten or more than ten separate occasions.

The control circuitry may be configured to cause aerosolization of one portion of aerosol generating material at any one time.

The control circuitry may be configured to perform an aerosolization process on the first portion of aerosol generating material on two separate occasions.

The one or more aerosol generating components may be heating elements.

The control circuitry may be configured to cause heating of a first portion of the aerosol generating material at least on two separate occasions before causing heating of a second portion of the aerosol generating material.

The control circuitry may be configured to cause sequential heating of each portion of aerosol generating material on one occasion, before causing heating of the first portion of aerosol generating material on a second occasion.

The control circuitry may be configured to receive a signal signifying a users intent to generate aerosol, and in response to receiving the signal, cause heating of a portion of the aerosol generating material.

The control circuitry may be configured to heat the one or more heating elements to a. temperature no greater than 350° C.

The control circuitry may be configured to heat the one or more heating elements to an operational temperature at which aerosol is generated for no longer than 10 consecutive seconds.

Each heating element may have an areal extent no greater than 130 mm².

The aerosol generating material may be an amorphous solid.

The amorphous solid may have a thickness in the range of 0.05 mm to 2 mm.

According to a second aspect of certain embodiments there is provided an aerosol provision system for generating aerosol from an aerosol generating material, wherein the system comprises: an aerosol generating article comprising a plurality of portions of aerosol generating material; one or more aerosol generating components arranged to aerosolize different portions of the aerosol generating material; and control circuitry for supplying power to the one or more aerosol generating components, wherein the control circuitry is configured to perform an aerosolization process on a first portion of the aerosol generating material on at least two separate occasions.

The second aspect may include any of the optional features described herein in relation to the first aspect.

According to a third aspect of certain embodiments there is provided an aerosol generating article comprising a plurality of portions of aerosol generating material, wherein each of the plurality of portions of aerosol generating material has a thickness of between 0.05 mm to 2 mm

According to a fourth aspect of certain embodiments there is provided a method of generating aerosol from an aerosol generating article comprising aerosol generating material, method comprising; performing a first aerosolization process on a first portion of the aerosol generating material; and performing a second aerosolization process on the first portion of the aerosol generating material, wherein the first and second aerosolization processes are separate from one another.

According to a fifth aspect of certain embodiments there is provided an aerosol provision device for use with an aerosol generating article comprising aerosol generating material, the aerosol provision device comprising: one or more aerosol generating means arranged to aerosolize different portions of the aerosol generating material; and control means for supplying power to the one or more aerosol generating means, wherein the control means is configured to perform an aerosolization process on a first portion of the aerosol generating material on at least two separate occasions.

It will be appreciated that features and aspects of the invention described above in relation to the first and other aspects of the invention are equally applicable to, and may be combined with, embodiments of the invention according to other aspects of the invention as appropriate, and not just in the specific combinations described above.

### BRIEF DESCRIPTION OF THE DRAWINGS

Embodiments of the invention will now be described, by way of example only, with reference to the accompanying drawings, in which:

FIG. 1 is a cross-section of a schematic representation of an aerosol provision system comprising an aerosol provision device and a aerosol generating article, the device comprising a plurality of heating elements and the article comprising a plurality of portions of aerosol generating material;

FIGS. 2A to 2C are a variety of views from different angles of the aerosol provision article of FIG. 1;

FIG. 3 is cross-sectional, top-down view of the heating elements of the aerosol provision device of FIG. 1;

FIG. 4 is an example method in accordance with aspects of the present disclosure for heating a plurality of portions of aerosol generating material using the device of FIG. 1, wherein each portion of aerosol generating material is heated on at least two occasions;

FIG. 5 is an example of a cross-section of a schematic representation of an aerosol provision system comprising an aerosol provision device and a aerosol generating article, the device comprising a plurality of induction work coils and the article comprising a plurality of portions of aerosol generating material and corresponding susceptor portions; and

FIGS. 6A to 6C are a variety of views from different angles of the aerosol provision article of FIG. 5.

### DETAILED DESCRIPTION

Aspects and features of certain examples and embodiments are discussed/described herein. Some aspects and features of certain examples and embodiments may be implemented conventionally and these are not discussed/described in detail in the interests of brevity. it will thus be appreciated that aspects and features of apparatus and methods discussed herein which are not described in detail may be implemented in accordance with any conventional techniques for implementing such aspects and features.

The present disclosure relates to a “non-combustible” aerosol provision system. A “non-combustible” aerosol provision system is one where a constituent aerosolizable material of the aerosol provision system (or component thereof) is not combusted or burned in order to facilitate delivery of an aerosol to a user. Furthermore, and as is common in the technical field, the terms “vapor” and “aerosol”, and related terms such as “vaporize”, “volatilize” and “aerosolize”, may generally be used interchangeably.

In some implementations, the non-combustible aerosol provision system is an electronic cigarette, also known as a vaping device or electronic nicotine delivery system (END), although it is noted that the presence of nicotine in the aerosolizable material is not a requirement. Throughout the following description the term “e-cigarette” or “electronic cigarette” is sometimes used but this term may be used interchangeably with aerosol (vapor) provision system. Typically, the non-combustible aerosol provision system may comprise a non-combustible aerosol provision device and an article (sometimes referred to as a consumable) for use with the non-combustible aerosol provision device. However, it is envisaged that articles which themselves comprise a means for powering an aerosol generating component may themselves form the non-combustible aerosol provision system.

The article, part or all of which, is intended to be consumed during use by a user. The article may comprise or consist of aerosolizable material. article may comprise one or more other elements, such as a filter or an aerosol modifying substance (e.g. a component to add a flavor to, or otherwise alter the properties of, an aerosol that passes through or over the aerosol modifying substance).

Non-combustible aerosol provision systems often, though not always, comprise a modular assembly including both a reusable aerosol provision device and a replaceable article. In some implementations, the non-combustible aerosol provision device may comprise a power source and a controller (or control circuitry). The power source may, for example, be an electric power source, such as a battery or rechargeable battery. In some implementations, the non-combustible aerosol provision device may also comprise an aerosol generating, component. However, in other implementations the article may comprise partially, or entirely, the aerosol generating component.

In some implementations, the aerosol generating component is a heater capable of interacting with the aerosolizable material so as to release one or more volatiles from the aerosolizable material to form an aerosol. In some embodiments, the aerosol generating component is capable of generating an aerosol from the aerosolizable material without heating. For example, the aerosol generating component may be capable of generating an aerosol from the aerosolizable material without applying heat thereto, for example via one or more of vibrational, mechanical, pressurization or electrostatic means.

The article for use with the non-combustible aerosol provision device generally comprises an aerosolizable material. Aerosolizable material, which also may be referred to herein as aerosol generating material, is material that is capable of generating aerosol, for example when heated, irradiated or energized in any other way. Aerosolizable material may, for example, be in the form of a solid, liquid or gel which may or may not contain nicotine and/or flavorants. In the following disclosure, the aerosolizable material is described as comprising an “amorphous solid”, which may alternatively be referred to as a “monolithic solid” (i.e. non-fibrous). In some implementations, the amorphous solid may be a dried gel. The amorphous solid is a solid material that may retain some fluid, such as liquid, within it. In some implementations, the aerosolizable material may for example comprise from about 50 wt %, 60 wt % or 70 wt % of amorphous solid, to about 90 wt %, 95 wt % or 100 wt % of amorphous solid. However, it should be appreciated that principles of the present disclosure may be applied to other aerosolizable materials, such as tobacco, reconstituted tobacco, a liquid, such as an e-liquid, etc.

As appropriate, the aerosolizable material may comprise any one or more of: an active constituent, a carrier constituent, a flavor, and one or more other functional constituents.

The active constituent as used herein may be a physiologically active material, which is a material intended to achieve or enhance a physiological response. The active constituent may for example be selected from nutraceuticals, nootropics, psychoactives. The active constituent may be naturally occurring or synthetically obtained. The active constituent may comprise for example nicotine, caffeine, taurine, theine, vitamins such as B6 or B12 or C, melatonin, cannabinoids, or constituents, derivatives, or combinations thereof. The active constituent may comprise one or more constituents, derivatives or extracts of tobacco, cannabis or another botanical. As noted herein, the active constituent may comprise one or more constituents, derivatives or extracts of cannabis, such as one or more cannabinoids or terpenes.

In some embodiments, the active constituent comprises nicotine. In some embodiments, the active constituent comprises caffeine, melatonin or vitamin B12.

As noted herein, the active constituent may comprise or be derived from one or more botanicals or constituents, derivatives or extracts thereof. As used herein, the term “botanical” includes any material derived from plants including, but not limited to, extracts, leaves, bark, fibres, stems, roots, seeds, flowers, fruits, pollen, husk, shells or the like. Alternatively, the material may comprise an active compound naturally existing, in a botanical, obtained synthetically. The. material may be in the form of liquid, gas, solid, powder, dust, crushed particles, granules, pellets, shreds, strips, sheets, or the like.

Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove. cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, dainien, marjoram, olive, lemon balm, lemon basil, chive, carni, verbena, tarragon, geranium, mulberry, ginseng, Mealline, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v.,Mentha piperita c.v, Mentha spicata crispa, Mentha cardifolia, Memtha longifolia, Mentha suaveolens variegata, Mentha pulegium, Mentha spicata c.v. and Mentha suaveolens

In some embodiments, the active constituent comprises or is derived from one or more botanicals or constituents, derivatives or extracts thereof and the botanical is tobacco.

In some embodiments, the active constituent comprises or derived from one or more botanicals or constituents, derivatives or extracts thereof and the botanical is selected from eucalyptus, star anise, cocoa and hemp.

In some embodiments, the active constituent comprises or derived from one or more botanicals or constituents, derivatives or extracts thereof and the botanical is selected from rooibos and fennel.

In some implementations, the aerosolizable material comprises a flavor (or flavorant).

As used herein, the terms “flavor” and “flavorant” refer to materials which, where local regulations pennit, may be used to create a desired taste, aroma or other somatosensorial sensation in a product for adult. consumers, They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, inatcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, (Julian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, darnien, marjoram, olive, lemon balm, lemon basil, chive, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. in some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may he, but is not limited to, vanillyl ethyl ether and a suitable cooling agent may be, but not limited to eucolyptol, WS-3.

The carrier constituent may comprise one or more constituents capable of forming an aerosol. In some embodiments, the carrier constituent may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

In some embodiments, die carrier constituent comprises one or more polyhydric alcohols, such as propylene glycol, triethylene glycol, 1,3-butanediol and glycerin; esters of polyhydric alcohols, such as glycerol mono-, di- or triacetate and/or aliphatic esters of mono-, di- or polvcarboxvlic acids, such as dimethyl dodecanedioate and dirnethyl tetradecanedioate.

The one or more other functional constituents may comprise one or more of pH regulators, coloring agents, preservatives, binders, fillers, stabilizers, and/or antioxidants.

The aerosolizable material may also comprise an acid. The acid may be an organic acid. In some of these embodiments, the acid may be at least one of a monoprotic acid, a diprotic acid and a triprotic acid. In some such embodiments, the acid may contain at least one carboxyl functional group. In some such embodiments, the acid may be at least one of an alpha-hydroxy acid, carboxylic acid, dicarboxylic acid, tricarboxylic acid and keto acid. In some such embodiments, the acid may be an alpha-keto acid. In some such embodiments, the acid may be at least one of succinic acid, lactic acid, benzoic acid, citric acid, tartaric acid, fumaric acid, levulinic acid, acetic acid, malic acid, formic acid, sorbic acid, benzoic acid, propanoic and pyruvic acid.

Suitably the acid is lactic acid. In other embodiments, the acid is benzoic acid. In other embodiments the acid may be an inorganic acid. In some of these embodiments the acid may be a mineral acid. in some such embodiments, the acid may be at least one of sulphuric acid, hydrochloric acid, boric acid and phosphoric acid. In some embodiments, the acid is levulinic acid.

The inclusion of an acid is particularly preferred in embodiments in which the aerosolizable material comprises nicotine. In such embodiments, the presence of an acid may stabilize dissolved species in the slurry from which the aerosolizable material is formed. The presence of the acid may reduce or substantially prevent evaporation of nicotine during drying of the slurry, thereby reducing loss of nicotine during manufacturing.

In some embodiments, the aerosolizable material comprises one or more cannabinoid compounds selected from the group consisting of: cannabidiol (CBD), tetrahydrocannabinol (THC), tetrahydrocannabinolic acid (THCA), cannabidiolic acid (CBDA), cannabinol (CBN), cannahigerol (CBG), cannabichromene (CBC), cannabicycloi (CBL), cannahivarin (CBV), tetrahydrocannabivarin (THCV), cannabidivarin (CBDV), cannabichromevarin (CBCV), carmabigerovarin (CBGV), cannabigerol monomethyl ether (CBGM) and cannabielsoin (CBE), cannabicitran (CBT).

The aerosolizable material may comprise one or more cannabinoid compounds selected from the group consisting of cannabidiol (CBD) and THC (tetrahydrocannabinol).

The aerosolizable material may comprise cannabidiol (CBD).

The aerosolizable material may comprise nicotine and cannabidiol (CBD).

The aerosolizable material may comprise nicotine, cannabidiol (CBD), and. THC (tetrahydrocannabinol). The aerosolizable material may be present on or in a carrier support (or carrier component) to form a substrate. The carrier support may, for example, be or comprise paper, card, paperboard, cardboard, reconstituted aerosolizable material, a plastics material, a ceramic material, a composite material, glass, a metal, or a metal alloy.

In some implementations, the article for use with the non-combustible aerosol provision device may comprise aerosolizable material or an area for receiving aerosolizable material.

In some implementations, the article for use with the non-conibustible aerosol provision device may comprise a mouthpiece, or alternatively the non-combustible aerosol provision device may comprise a mouthpiece which communicates with the article. The area for receiving aerosolizable material may be a storage area for storing aerosolizable material.

For example, the storage area may be a reservoir.

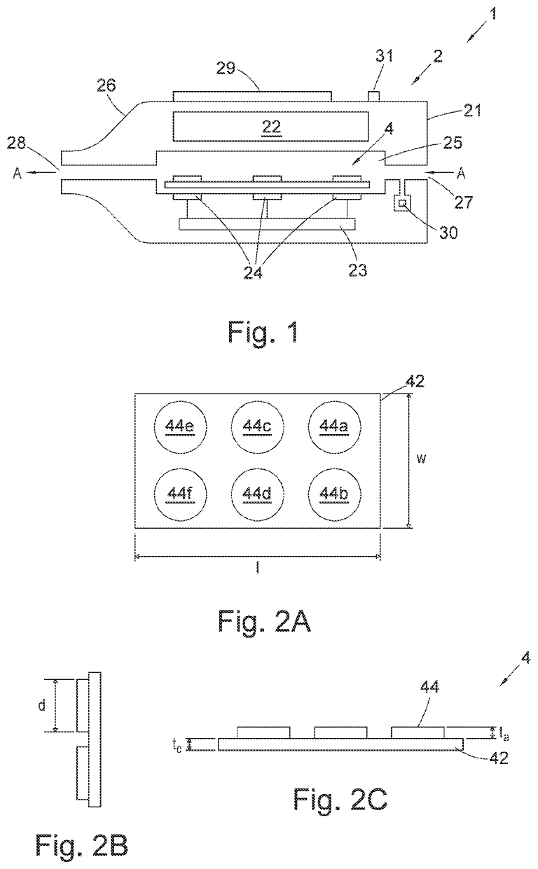

FIG. 1 is a cross-sectional view through a schematic representation of an aerosol provision system 1 in accordance with certain embodiments of the disclosure. The aerosol provision system 1 comprises two main components, namely an aerosol provision device 2 and an aerosol generating article 4.

The aerosol provision device 2 comprises an outer housing 21, a power source 22, control circuitry 23, a plurality of aerosol generating components 24, a receptacle 25, a mouthpiece end 26, an air inlet 27, an air outlet 28, a touch-sensitive panel 29, an inhalation sensor 30, and an end of use indicator 31.

The outer housing 21 may be formed from any suitable material, for example a plastics material. The outer housing 21 is arranged such that the power source 22, control circuitry 23, aerosol generating components 24, receptacle 25 and inhalation sensor 30 are located within the outer housing 21. The outer housing 21 also defines the air inlet 27 and air outlet 28, described in more detail below. The touch sensitive panel 29 and end of use indicator are located on the exterior of the outer housing 21.

The outer housing 21 further includes a mouthpiece end 26. The outer housing 21 and mouthpiece end 26 are formed as a single component (that is, the mouthpiece end 26 forms a part of the outer housing 213. The mouthpiece end 26 is defined as a region of the outer housing 21 which includes the air outlet 28 and is shaped in such a way that a user may comfortably place their lips around the mouthpiece end 26 to engage with air outlet 28. In FIG. 1, the thickness of the outer housing 21 decreases towards the air outlet 28 to provide a relatively thinner portion of the device 2 which may be more easily accommodated by the lips of a user. In other implementations, however, the mouthpiece end 26 may be a removable component that is separate from but able to be coupled to the outer housing 21, and may be removed for cleaning and/or replacement with another mouthpiece end 26.

The power source 22 is configured to provide operating, power to the aerosol provision device 2. The power source 22 may be any suitable power source, such as a battery. For example, the power source 22 may comprise a rechargeable battery, such as a Lithium Ion battery. The power source 22 may be removable or form an integrated part of the aerosol provision device 2. In some implementations, the power source 22 may be recharged through connection of the device 2 to an external power supply (such as mains power) through an associated connection port, such as a USB port (not shown) or via a suitable wireless receiver (not shown). The control circuitry 23 is suitably configured/programmed to control the operation of the aerosol provision device to provide certain operating functions of aerosol provision device 2. The control circuitry 23 may be considered to logically comprise various sub-units/circuitry elements associated with different aspects of the aerosol provision devices operation. For example, the control circuitry 23 may comprise a logical sub-unit for controlling the recharging of the power source 22, Additionally, the control circuitry 23 may comprise a logical sub-unit for communication, e.g, to facilitate data transfer from or to the device 2. However, a primary function of the control circuitry 23 is to control the aerosolization of aerosol generating material, as described in more detail below. It will be appreciated the functionality of the control circuitry 23 can be provided in various different ways, for example using one or more suitably programmed programmable computer(s) and/or one or more suitably configured application-specific integrated circuit(s)/circuitry/chip(s) chipset(s) configured to provide the desired functionality. The control circuitry 23 is connected to the power supply 23 and receives power from the power source 22 and may be configured to distribute or control the power supply to other components of the aerosol provision device 2.

In the described implementation, the aerosol provision device 2 further comprises a receptacle 25 which is arranged to receive an aerosol generating article 4.

The aerosol generating article 4 comprises a carrier component 42 and aerosol generating material 44. The aerosol generating article 4 is shown in more detail in FIGS. 2A to 2C. FIG. 2A is a top-down view of the article 4, FIG. 2B is an end-on view along the longitudinal (length) axis of the article 4, and FIG. 2C is a side-on view along the width axis of the article

The article 4 comprises a carrier component 42 which in this implementation is formed of card. The carrier component 42 forms the majority of the article 4, and acts as a base for the aerosol generating material 44 to be deposited on.

The carrier component 42 is broadly cuboidal in shape has a length I, a width w and a thickness t_{c} as shown in FIGS. 2A to 2C. By way of a concrete example, the length of the carrier component 42 may be 30 to 80 mm, the width may be 7 to 25 mm, and the thickness may be between 0.2 to 1 mm. However, it should be appreciated that the above are exemplary dimensions of the carrier component 42, and in other implementations the carrier component 42 may have different dimensions as appropriate. In some implementations, the carrier component 42 may comprise one or more protrusions extending in the length and/or width directions of the carrier component 42 to help facilitate handling of the article 4 by the user. In the example shown in FIGS. 1 and 2, the article 4 comprises a plurality of discrete portions of aerosol generating material 44 disposed on a surface of the carrier component 42. More specifically, the article 4 comprises six discrete portions of aerosol generating inaterial 44, labelled 44a to 44f, disposed in a two by three array. However, it should be appreciated that in other implementations a greater or lesser number of discrete portions may be provided, and/or the portions may be disposed in a different array (e.g., a one by six array). In the example shown, the aerosol generating material 44 is disposed at discrete, separate locations on a single surface of the component carrier 42. The discrete portions of aerosol generating material 44 are shown as having a circular footprint, although it should be appreciated that the discrete portions of aerosol generating material 44 may take any other footprint, such as square or rectangular, as appropriate. The discrete portions of aerosol generating material 44 have a diameter d and a thickness ta as shown in FIGS. 2A to 2C. The thickness ta may take any suitable value, for example the thickness ta may be in the range of 50 pm to 1.5 mm. In some embodiment, the thickness ta is from about 50 pm to about 200 pm, or about 50 pm to about 100 pm, or about 60 pm to about 90 pm, suitably about 77 pm. In other embodiments, the thickness ta may be greater than 200 pm, e.g., from about 50 pm to about 400 pm, or to about 1 mm, or to about 1.5 mm.

The discrete portions of aerosol generating material 44 are separate from one another such that each of the discrete portions may be energized (e.g., heated) individually/selectively to produce an aerosol, in some implementations, the portions of aerosol generating material 44 may have a mass no greater than 20 mg, such that the amount of material to be aerosolized by a given aerosol generating component 24 at any one time is relatively low. For example, the mass per portion may be equal to or lower than 20 mg, or equal to or lower than 10 mg, or equal to or lower than 5 mg. Of course, it should be appreciated that the total mass of the article 4 may be greater than 20 mg.

In the described implementation, the aerosol generating material 44 is an amorphous solid. Generally, the amorphous solid may comprise a gelling agent (sometimes referred to as a binder) and an aerosol generating agent (which might comprise glycerol, for example). Optionally, the aerosol generating material may comprise one or more of the following an active substance (which may include a tobacco extract), a flavorant, an acid, and a filler. Other components may also be present as desired. Suitable active substances, flavorants, acids and tillers are described above in relation to the aerosolirable material.

Thus the aerosol generating agent may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic, acid, and propylene carbonate.

In some embodiments, the aerosol generating agent comprises one or more polyhydric alcohols, such as propylene glycol, triethylene glycol, 1,3-butanediol and glycerin; esters of polyhydric alcohols, such as glycerol mono-, di- or triacetate; and/or aliphatic esters of mono-, di- or polycarboxylic acids, such as dimethyl dodecanedioate and dimethyl tetradecanedioate.

The gelling agent may comprise one or more compounds selected from cellulosic gelling agents, non-cellulosic gelling agents, guar gum, acacia gum and mixtures thereof.

In some embodiments, the cellulosic gelling agent is selected from the group consisting of hydroxymethyl cellulose, hydroxyethyl cellulose, hydroxypropyl cellulose, carboxymethylcellulose (CMC), hydroxypropyl methylcellulose (HPMC), methyl cellulose, ethyl cellulose, cellulose acetate (CA), cellulose acetate butyrate (CAB), cellulose acetate propionate (CAP) and combinations thereof.

In some embodiments, the gelling agent comprises (or is) one or more of hydroxyethyl cellulose, hydroxypropyl cellulose, hydroxypropyl methylcellulose (HPMC), carboxymethylcellulose, guar gum, or acacia gum.

In some embodiments, the gelling agent comprises (or is) one or more non-cellulosic gelling agents, including, but not limited to, agar, xanthan gum, gum Arabic, guar gum, locust bean gum, pectin, carrageenan, starch, alginate, and combinations thereof. In preferred embodiments, the non-cellulose based gelling agent is alginate or agar.

The aerosol-generating material may comprise an acid. The acid may be an organic acid. In some of these embodiments, the acid may be at least one of a inonoprotic acid, a diprotic acid and a triprotic acid. In some such embodiments, the acid may contain at least one carboxyl functional group. In some such embodiments, the acid may be at least one of an alpha-hydroxy acid, carboxylic acid, dicarboxylic acid, tricarboxylic acid and keto acid. In some such embodiments, the acid may be an alpha-keto acid.

In some such embodiments, the acid may be at least one of succinic acid, lactic acid, benzoic acid, citric acid, tartaric acid, fumaric acid, levulinic acid, acetic acid, malic acid, formic acid, sorbin acid, benzoic acid. propanoic and pyruvic acid.

Suitably the acid is lactic acid. In other embodiments, the acid is benzoic acid. In other embodiments the acid may be an inorganic acid. In some of these embodiments the acid may be a mineral acid. In some such embodiments, the acid may be at least one of sulphuric acid, hydrochloric acid, boric acid and phosphoric acid. In some embodiments, the acid is levulinic acid.

The inclusion of an acid is particularly preferred in embodiments in which the aerosol generating material comprises nicotine, in such embodiments, the presence of an acid may stabilize dissolved species in the slurry from which the aerosol-generating material is formed. The presence of the acid may reduce or substantially prevent evaporation of nicotine during drying of the slurry, thereby reducing loss of nicotine during manufacturing.

In certain embodiments, the aerosol-generating material comprises a gelling agent comprising a cellulosic gelling agent and/or a non-cellulosic gelling agent, an active substance and an acid.

In some embodiments, the aerosol-generating material comprises one or more cannabinoid compounds selected from the group consisting of: cannabidiol (CBD), tetrahydrocannabinol (THC), tetrahydrocannabinolic acid (THCA), cannabidiolic acid (CBDA), cannabinol (CBN), cannabigerol (CBG), cannabichromene (CBC), cannabicyclol (CBL), cannabivarin (CBV), tetrahydrocannabivarin (THCV), camiabidivarin (CBDV), cannabichrorrievarin (CBCV), cannabigerovarin (CBGV), cannabigerol monomethyl ether (CBGM) and cannabielsoin (CBE), cannabicitran (CBT).

The aerosol-generating material may comprise one or more cannabinoid compounds selected from the group consisting of cannabidiol (CBD) and THC (tetrahydrocannabinol).

The aerosol-generating material may comprise cannabidiol (CBD).

The aerosol-generating material may comprise nicotine and cannabidiol (CBD).

The aerosol-generating material may comprise nicotine, cannabidiol (CBD), and THC (tetrahydrocannabinol). An amorphous solid aerosolizable inaterial offers some advantages over other types of aerosolizable materials commonly found in some electronic aerosol provision devices. For example, compared to electronic aerosol provision devices which aerosolize a liquid aerosolizable material, the potential for the amorphous solid to leak or otherwise flow from a location at which the amorphous solid is stored is greatly reduced.

This means aerosol provision devices or articles may be more cheaply manufactured as the components do not necessarily require the same liquid-tight seals or the like to be used.

Compared to electronic aerosol provision devices which aerosolize a solid aerosolizable material, e.g., tobacco, a comparably lower mass of amorphous solid material can be aerosolized to generate an equivalent amount of aerosol (or to provide an equivalent amount of a constituent in the aerosol, e.g., nicotine). This is partially due to the fact that an amorphous solid can be tailored to not include unsuitable constituents that might be found in other solid aerosolizable materials (e.g., cellulosic material in tobacco, for example). For example, in some iinplementations, the mass per portion of amorphous solid is no greater than 20 mg, or no greater than 10 mg, or no greater than 5 mg. Accordingly, the aerosol provision device can supply relatively less power to the aerosol generating component andlor the aerosol generating component can be comparably smaller to generate a similar aerosol, thus meaning the energy requirements for the aerosol provision device may be reduced.

The amorphous solid may comprise a colorant. The addition of a colorant may alter the visual appearance of the amorphous solid. The presence of colorant in the amorphous solid may enhance the visual appearance of the amorphous solid and the aerosol-generating material. By adding a colorant to the amorphous solid, the amorphous solid may be color-matched to other components of the aerosol-generating, material or to other components of an article comprising the amorphous solid.

A variety of colorants may be used depending on the desired color of the amorphous solid. The color of amorphous solid may be, for example, white, green, red, pulpit, blue, brown or black. Other colors are also envisaged. Natural or synthetic colorants, such as natural or synthetic dyes, food-grade colorants and pharmaceutical-grade colorants may be used. In certain embodiments, the colorant is caramel, which may confer the amorphous solid with a brown appearance. In such embodiments, the color of the amorphous solid may be similar to the color of other components (such as tobacco material) in an aerosol generating material comprising the amorphous solid. in some embodiments, the addition of a colorant to the amorphous solid renders it visually indistinguishable from other components in the aerosol-generating material.

The colorant may be incorporated during the formation of the amorphous solid (e.g. when forming a slurry comprising the materials that form the amorphous solid) or it may be applied to the amorphous solid after its formation (e.g. by spraying it onto the amorphous solid). In some embodiments, the amorphous solid comprises tobacco extract. In these embodiments, the amorphous solid may have the following composition (by Dry Weight Basis, DWB) gelling agent (preferably comprising alginate) in an amount of from about 1 wt % to about 60 wt %, or about 10 wt % to 30 wt %, or about 15 wt % to about 25 wt %; tobacco extract in an amount of from about 10 wt % to about 60 wt %, or from about 40 wt % to 55 wt %. or from about 45 wt % to about 50 wt %; aerosol generating agent (preferably comprising glycerol) in an amount of from about 5 wt % to about 60 wt %, or from about 20 wt % to about 40 wt %, or from about 25 wt % to about 35 wt % (DWI3). The tobacco extract may be from a single -variety of tobacco or a blend of extracts from different varieties of tobacco. Such amorphous solids may be referred to as “tobacco amorphous solids”, and may be designed to deliver a tobacco-like experience when aerosolized.

In one embodiment, the amorphous solid comprises about 20 wt % alginate gelling agent, about 48 wt % Virginia tobacco extract and about 32 wt % glycerol (DWB).

The amorphous solid of these embodiments may have any suitable water content. For example, the amorphous solid may have a water content of from about 5 wt % to about 15 wt %, or from about 7 wt % to about 13 wt %, or about 10 wt %.

Suitably, in any of these embodiments, the amorphous solid has a thickness to of from about 50 pm to about 200 pm, or about 50 pm to about 100 pm, or about 60 pm to about 90 pm, suitably about 77 pm.

In some implementations, the amorphous solid may comprise 0.5-60 wt % of a gelling agent; and 5-80 wt % of an aerosol generating agent, wherein these weights are calculated on a dry weight basis. Such amorphous solids may contain no flavor, no acid and no active substance. Such amorphous solids may be referred to as “aerosol generating agent rich” or “aerosol generating agent amorphous solids”. More generally, this is an example of an aerosol generating agent rich aerosol generating material which, as the name suggests, is a portion of aerosol generating material which is designed to deliver aerosol generating agent when aerosolited.

In these implementations, the amorphous solid may have the following composition (DWB): gelling agent in an amount of from about 5 wt % to about 40 wt %, or about 10 wt % to 30 wt %, or about 15 wt % to about 25 wt %; aerosol generating agent in an amount of from about 10 wt % to about 50 wt %, or from about 20 wt % to about 40 wt %, or from about 25 wt % to about 35 wt % (DWB).

In some other implementations, the amorphous solid may comprise 0.5-60 wt % of a gelling agent; 5-80 wt % of an aerosol generating agent; and 1-60 wt % of a flavor, wherein these weights are calculated on a dry weight basis, Such amorphous solids may contain flavor, but no active substance or acid. Such amorphous solids may be referred to as “flavorant rich” or “flavor amorphous solids”. More generally, this is an example of a flavorant rich aerosol generating material which, as the name suggests, is a portion of aerosol generating material which is designed to deliver flavorant when aerosolized.

In these implementations, the amorphous solid may have the following composition (DWB): gelling agent in an amount of from about 5 wt % to about 40 wt %, or about 10 wt % 30 wt %, or about 15 wt % to about 25 wt %; aerosol generating agent in an amount of from about 10 wt % to about 50 wt %, or from about 20 wt % to about 40 wt %, or from about 25 wt % to about 35 wt % (DWB), flavor in an amount of from about 30 wt % to about 60 wt %, or from about 40 wt % to 55 wt %, or from about 45 wt % to about 50 wt %.

In some other implementations, the amorphous solid may comprise 0.5-60 wt % of a gelling agent; 5-80 wt % of an aerosol generating agent; and 5-60 wt % of at least one active substance, wherein these weights are calculated on a dry weight basis. Such amorphous solids may contain an active substance, but no flavor or acid. Such amorphous solids may be referred to as “active substance rich” or “active substance amorphous solids”. For example, in one implementation, the active substance may be nicotine, and as such an amorphous solid as described above comprising nicotine may be referred to as a “nicotine amorphous solid”. More generally, this is an example of an active substance rich aerosol generating material which, as the name suggests, is a portion of aerosol generating material which is designed to deliver an active substance when aerosolized.

In these implementations, amorphous solid may have the following composition (DWB): gelling agent in an amount of from about 5 wt % to about 40 wt %, or about 10 wt % to 30 wt %, or about 15 wt % to about 25 wt %; aerosol generating agent in an amount of from about 10 wt % to about 50 wt %, or from about 20 wt % to about 40 wt %, or from about 25 wt % to about 35 wt % (DWB), active substance in an amount of from about 30 wt % to about 60 wt %, or from about 40 wt % to 55 wt %, or from about 45 wt % to about 50 wt %.

In some other implementations, the amorphous solid may comprise 0.5-60 wt % of a gelling agent; 5-80 wt % of an aerosol generating agent; and 0.1-10 wt % of an acid, wherein these weights are calculated on a dry weight basis. Such amorphous solids may contain acid, but, no active substance and flavorant. Such amorphous solids may be referred to as “acid rich” or “acid amorphous solids”. More generally, this is an example of an acid rich aerosol generating material which, as the name suggests, is a portion of aerosol generating material which is designed to deliver an acid when aerosolized.

In these implementations, the amorphous solid may have the following composition (DWB): gelling agent in an amount of from about 5 wt % to about 40 wt %, or about 10 wt % to 30 wt %, or about 5 wt % to about 25 wt %; aerosol generating agent in an amount of from about 10 wt % to about 50 wt %, or from about 20 wt % to about 40 wt %, or from about 25 wt % to about 35 wt % (DWB), acid in an amount of from about 0.1 wt % to about 5 wt %, or from about 0.5 wt % to 7 wt %, or from about 11 wt % to about 5 wt %, or form about 1 wt % to about 3 wt %.

The article 4 may comprise a plurality of portions of aerosol generating material all formed form the same aerosol generating material (e.g., one of the amorphous solids described above). Alternatively, the article 4 may comprise a plurality of portions of aerosol generating material 44 where at least two portions are formed from different aerosol generating material (e.g., one of the amorphous solids described above).

The receptacle 25 is suitable sized to removably receive the article 4 therein. Although not shown, the device 2 may comprise a hinged door or removable part of the outer housing 21 to permit access to the receptacle 25 such that a user may insert andlor remove the article 4 from the receptacle 25. The hinged door or removable part of the outer housing 21 may also act to retain the article 4 within the receptacle 25 when closed. When the aerosol generating article 4 is exhausted or the user simply wishes to switch to a different aerosol generating article 4. the aerosol generating article 4 may be removed from the aerosol provision device 2 and a replacement aerosol generating article 4 positioned in the receptacle 25 in its place. Alternatively, the device 2 may include a permanent opening that communicates with the receptacle 25 and through which the article 4 can be inserted. into the receptacle 25. In such implementations, a retaining mechanism for retaining the article 4 within the receptacle 25 of the device 2 may be provided.

As seen in FIG. 1, the device 2 comprises a number of aerosol generating components 24. In the described implementation, the aerosol generating components 24 are heating elements 24, and more specifically resistive heating elements 24. Resistive heating elements 24 receive ap electrical current and convert the electrical energy into heat. The resistive heating elements 24 may be formed from, or comprise, any suitable resistive heating material, such as NiChrome (Ni20Cr80), which generates heat upon receiving an electrical current. In one implementation, the heating elements 24 may comprise an electrically insulating substrate on which resistive tracks are disposed.

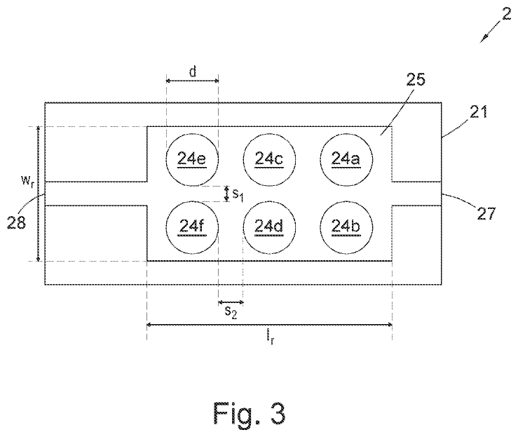

FIG. 3 is a cross-sectional, top-down view of the aerosol provision device 2 showing the arrangement of the heating elements 24 in more detail. In FIGS. 1 and 3, the heating elements 24 are positioned such that a surface of the heating element 24 forms a part of the surface of the receptacle 25. That is, an outer surface of the heating elements 24 is flush with the inner surface of the receptacle. More specifically, the outer surface of the heating element 24 that is flush with the inner surface of the receptacle 25 is a surface of the heating element 24 that is heated (i.e., its temperature increases) when an electrical current is passed through the heating element 24.

In the present example, the heating element 24 is formed of an electrically-conductive plate, which defines the surface of the heating element that is arranged to increase temperature. The electrically-conductive plate may be formed of a metallic material, for example, NiChrome, which generates heat when a current is passed through the electrically-conductive plate. In other implementatiims, a separate electrically-conductive track may pass on a surface of, or through, a second material (e.g., a metal material or a ceramic material), with the electrically-conductive track generating heat that is transferred to the second material. That is, the second material in combination with the electrically-conductive track form the heating element 24. In the latter example, the surface of the heating element that is arranged to increase in temperature is defined by the perimeter of the second material.

In the described implementation, the surfaces of the heating elements 24 that are arranged to increase in temperature are also planar and are generally located in a plane parallel to the wall of the receptacle 25. However, in other implementations, the surfaces may be curved; that is to say, the plane in which the surfaces of the heating elements 24 are located may have a radius of curvature in one axis (e.g., the surface may be approximately parabolic).

The heating elements 24 are arranged such that, when the article 4 is received in the receptacle 25, each heating element 24 aligns with a corresponding discrete portion of aerosol generating material 44. Hence, in this example, six heating elements 24 are arranged in a two by three array broadly corresponding to the arrangement of the two by three array of the six discrete portions of aerosol generating material 44 shown in FIGS. 2A to 2C. However, as discussed above, the number of heating elements 24 may be different in different implementations, for example there may be 8, 10, 12, 14, etc. heating elements 24. In some implementations, the number of heating elements 24 is greater than or equal to six but no greater than 20.

More specifically, the heating elements 24 are labeled 24a to 24f in FIG. 3, and it should be appreciated that each heating element 24 is arranged to align with a corresponding portion of aerosol generating material 44 as denoted by the corresponding letter following the references 24/44. Accordingly, each of the heating elements 24 can be individually activated to heat a corresponding portion of aerosol generating material 44.

While the heating elements 24 are shown flush with the inner surface of the receptacle 25, in other implementations the heating elements 24 may protrude into the receptacle 25. In either case, the article 4 contacts the surfaces of the heating elements 24 when present in the receptacle 25 such that heat generated by the heating elements 24 is conducted to the aerosol generating material 44 through the carrier component 42.

The surfaces of the heating elements 24 have a diameter d, which is substantially the same as the diameter d of FIG. 2, although it should be appreciated in some implementations the diameters may be different. As shown m FIG. 3, the heating elements 24 are separated from one another in the length direction by a separation distance S2 and in the width direction by a separation distance Si. The separation distances S1 and S2 are set such that, when one portion of aerosol generation material is heated by one heating element (e.g., heating element 24a and corresponding portion 44a), the heat from this heating element 24a does not cause a substantial increase in the temperature of an adjacent portion of aerosol generating material, e.g., portions 44b and 44c. In other words, the separation distances S1 and S2 are arranged such that the adjacent portions of aerosol generating material are not inadvertently heated to an extent that the adjacent portions of aerosol generating material begin generating aerosol. The separation distances S1 and S2 may be influenced by the expected operational temperatures that the heating elements 24 are expected to operate at. Generally, a greater operational temperature will lead to a greater separation distance S1 and S2. The separation distances S1 and S2 may be the same or may differ, however for any given system the separation distances S1 and S2 may share a minimum distance. In this case, the minimum separation distance may be between 1.5 mm to 5 mm FIG. 3 also shows the receptacle having a length and a width wᵣ, discussed in more detail below.

In some implementations, to improve the heat-transfer efficiency, the receptacle may comprise components which apply a force to the surface of the carrier component 42 so as to press the carrier component 42 onto the heater elements 24, thereby increasing the efficiency of heat transfer via conduction to the aerosol generating material 44. Additionally or alternatively, the heater elements 24 may be configured to move in the direction towardslaway from the article 4, and may be pressed into the surface of carrier component 42 that does not: comprise the aerosol generating material 44.

In use, the device 2 (and more specifically the control circuitry 23) is configured to deliver power to the heating elements 24 in response to a user input. Broadly speaking, the control circuitry 23 is configured to selectively apply power to the heating elements 24 to subsequently heat the corresponding portions of aerosol generating material 44 to generate aerosol. When a user inhales on the device 2 (i.e., inhales at mouthpiece end 26), air is drawn into the device 2 through air inlet 27, into the receptacle 25 where it mixes with the aerosol generated by heating the aerosol generating material 44, and then to the user's mouth via air outlet 28. That is, the aerosol is delivered to the user through mouthpiece end 26 and air outlet 28.

Turning back to the operation of the device 2 of FIG. 1, the device 2 includes a touch-sensitive panel 29 and an inhalation sensor 30. Collectively, the touch-sensitive panel 29 and inhalation sensor 30 act as mechanisms for a receiving a user input to cause the generation of aerosol, and thus may more broadly be referred to as user input mechanisms. The received user input may be said to be indicative of a user's desire to generate aerosol. The touch-sensitive panel 29 may be a capacitive touch sensor and can be operated by a user of the device 2 placing their finger or another suitably conductive object (for example a stylus) on the touch-sensitive panel. In the described implementation, the touch-sensitive panel includes a region which can be pressed by a user to start aerosol generation. The control circuitry 23 may be configured to receive signaling from the touch-sensitive panel 29 and to use this signaling to determine if a user is pressing (i.e. activating) the region of the touch-sensitive panel 29. If the control circuitry 23 receives this signaling, then the control circuitry 23 is configured to supply power from the power source 22 to one or more of the heating elements 24. Power may be supplied for a predetermined time period (for example, three seconds) from the moment a touch is detected, or in response to the length of time the touch is detected for. In other implementations, the touch sensitive panel 29 may be replaced by a user actuatabie button or the like.

The inhalation sensor 30 may be a pressure sensor or microphone or the like configured to detect a drop in pressure or a flow of air caused by the user inhaling on the device 2. The inhalation sensor 30 is located in fluid communication with the air flow pathway (that is, in fluid communication with the air flow path between inlet 27 and outlet 28). In a similar manner as described above, the control circuitry 23 may be configured to receive signaling from the inhalation sensor and to use this signaling to dam:it:no if a user is inhaling on the aerosol provision system 1. If the control circuitry 23 receives this signaling, then the control circuitry 23 is configured to supply power from the power source 22 to one or more of the heating elements 24. Power may be supplied for a predetermined time period (for example, three seconds) from the moment inhalation is detected, or in response to the length of time the inhalation is detected for.

In the described example, both the touch-sensitive panel 29 and inhalation sensor 30 detect the user's desire to begin generating aerosol for inhalation. The control circuitry 23 may be configured to only supply power to the heating element 24 when signaling from both the touch-sensitive panel 29 and inhalation sensor 30 are detected. This may help prevent inadvertent activation of the heating elements 24 from accidental activation of one of the user input mechanisms. However, in other implementations, the aerosol provision system 1 may have only one of a touch sensitive panel 29 and an inhalation sensor 30.

These aspects of the operation of the aerosol provision system 1 (i.e. puff detection and touch detection) may in themselves be performed in accordance with established techniques (for example using conventional inhalation sensor and inhalation sensor signal processing techniques and using conventional touch sensor and touch sensor signal processing In techniques). In the implementation of the aerosol provision system I described above, a plurality of (discrete) portions of aerosol generating material 44 are provided which can be selectively aerosolized using the aerosol generating components 24. Such aerosol provision systems 1 offer advantages over other systems which are designed to heat a larger bulk quantity of material. In particular, for a given inhalation, only the selected portion (or portions) of aerosol generating material are aerosolized leading to a more energy efficient system overall.

In heated systems, several parameters affect the overall effectiveness of this system at delivering a sufficient amount of aerosol to a user on a per puff basis. On the one hand, the thickness of the aerosol generating material is important as this influences how quickly the aerosol generating material reaches an operational temperature (and subsequently generates aerosol). This may be important for several reasons, but may lead to more efficient use of energy from the power source 22 as the heating element may not need to be active for as long compared with heating a thicker portion of material. On the other hand, the total mass of the aerosol generating material that is heated affects the total amount of aerosol that can be generated, and subsequently delivered to the user. In addition, the temperature that the aerosol generating material is heated to may affect both how quickly the aerosol generating material reaches operational temperature and the amount of aerosol that is generated.

Amorphous solids (e.g., as described above) are particularly suited to the above application, in part because the amorphous solids are formed from selected ingredients constituents and so can be engineered such that a relatively high proportion of the mass is the useful (or deliverable) constituents (e.g., nicotine and glycerol, for example). As such, amorphous solids may produce a relatively high proportion of aerosol from a given mass as compared to some other aerosol generating materials (e.g., tobacco), meaning that relatively smaller portions of amorphous solid can output a comparable amount of aerosol. In addition, amorphous solids do not tend to easily flow (if at all) which means problems around leakage when using a liquid aerosol generating material, for example, are largely mitigated.

However, as mentioned, several factors may influence the effectiveness of these systems to generate aerosol on a puff-by-puff basis. As implied from the above, for a given temperature, the thinner the portion of aerosol generating material, the quicker the time from the start of heating to aerosol being generated, however, the lower the total mass of aerosol that can be generated from that portion. Additionally, for a given temperature, the greater the areal extent of the portion of aerosol generation material (that is, with reference to FIG. 3, the greater the diameter d) the more aerosol can be generated per portion of aerosol generating material. However, there is a tendency for aerosol provision systems to be miniaturized/handheld, so that the systems are portable. Devices which have a footprint much beyond the site of a palm of a human hand (e.g., 10 cm by 7 cm) start to become more difficult for a user to hold (particularly in one hand) and also tend to be more cumbersome and inconvenient to use. In the aerosol provision system 1 of FIGS. 1 to 3, a plurality of portions of aerosol generating material are to be vaporized, e.g., six portions as shown, which means there are practical limitations on how great the areal extent of the portions of aerosol generating material can be (which translates, from a device point of view, to limitations on the areal extent of the heating elements). This restriction is even more significant when the number of portions to be aerosolized increases e.g., up to 10 or 12, for example.

Assuming, as an example, that each portion of aerosol generating material is to be heated once (that is, each portion, when heated generates an aerosol sufficient for one user inhalation), for an article 4 which includes 12 portions of aerosol generating material having a circular cross-section and a diameter of, say, 12 mm and arranged in a 2×6 array, the length lᵣ of the receptacle 25 to receive such an article 4 may become on the order of 80 mm or greater, which leads to an overall device 2 having dimensions that start to go beyond the size of a user's palm as shown above.

In accordance with embodiments of the present disclosure, there is provided an aerosol provision device 2 for use with an aerosol generating article 4 comprising aerosol generating material 44, The aerosol provision device 2 comprises one or more aerosol generating components 24 arranged to aerosolize different portions of the aerosol generating material 44, and control circuitry 23 for supplying power to the one or more aerosol generating components 24. The control circuitry 23 is further configured to perform an aerosolization process on a first portion of the aerosol generating material on at least two separate occasions.

An aerosolization process here refers to any suitable process which can cause aerosolization of the portion of the aerosol generating material. In the described implementation, this includes heating of the aerosol generating material to a temperature and for a duration that are sufficient to generate aerosol from the portion of aerosol generating material. The temperature may be referred to as an operational temperature, and may be in the range of 160° C. to 350° C. However, in other implementations, performing any other form of energizing or agitating of the aerosol generating material to generate an aerosol may be considered as an aerosolization process,

On at least two separate occasions here is understood to mean that an aerosolization process is performed on two distinct occasions, e.g., a first occasion and on a second occasion wherein the two occasions are separated by a certain time. For example, the aerosol generating component may receive a first signal to generate aerosol (i.e., to perform a first aerosolization process) and then receive a second signal to generate aerosol (i.e., to perform a second aerosolization process) some time after die first aerosolization process has been completed. The certain time may be a time period in which aerosol is not-generated from the aerosol generating portion (i.e., a non-aerosolization process), in the example above in which the portion of aerosol generating material is heated, the heater element 24 may be raised to the operational temperature to generate aerosol from the portion of aerosol generating material as the first occurrence of the aerosolization process, subsequently cooled (or allowed to cool) to below the operational temperature as the non-aerosoliration process, and then controlled to reach the operational temperature for the second occasion of aerosolizing the portion of aerosol generating material, However, in some instances, it is not necessary that aerosolization has stopped between the first. and second aerosolization processes as some latent heat may still remain in the heating element after the first aerosolization process, but rather the first and second aerosolization processes signify distinct control steps performed by the control circuitry to cause aerosolization on separate occasions.

As described above, the present inventors have proposed an aerosol provision system 1 and a method for using the system 1, which involves aerosolizing a single portion of aerosol generating material on at least two separate occasions, in other words, the control circuitry performs a first aerosolization process on the portion of aerosol generating material to generate aerosol therefrom, wherein this process does not deplete the portion of the aerosol generation material, and then performs at least a second aerosolization process on the same portion of aerosol generating material at a later time to generate aerosol therefrom for a second time.

In this regard, the portion of aerosol generating material should have sufficient mass and be heated to a sufficient temperature that enables aerosol to be generated on at least two separate occasions. In some implementations, the aerosol that is generated as a result of the second aerosolization process should be substantially the same as the aerosol generated as a result of the first aerosolization process. In this regard, substantially the same should be understood to mean within 20%, or within 10%, or within 5% of a parameter used to characterize the aerosol (which may be the total aerosol mass produced or the amount or a proportion of a component of the aerosol, e.g., nicotine). It should be appreciated, however, that the first and second aerosolization processes may not be identical—that is, for example, the second aerosolization process may involve heating the portion of aerosol generating material at a higher temperature than in the first aerosolization process.

By performing an aerosolization process at least twice on a portion of aerosol generating material means that a greater design freedom may be afforded to the designer of the aerosol generation system 1. For example, in one scenario, if an article is to deliver 12 puffs, then fewer than twelve heating elements would be required in accordance with the principles of the present disclosure. For example, only six heating elements 24 may be required if each portion is able to be heated twice, with the heating elements 24 being arranged in a 2×3 array as shown in FIG. 3. Accordingly, the relative size of the receptacle 25 (e.g., the length lᵣ) can be made relatively smaller than if twice as many heating elements were required. In some implementations, the surface of each heating element 24 that is arranged to increase its temperature during heating, may have a surface area which is no greater than 130 mm². This equates to a maximum diameter d of the heating elements of around 12.9 mm. Accordingly, the minimum length lᵣ for the receptacle 25 having six heating elements arranged in a 2×3 array is around 40 mm; however this does not take into account the separation distances S1 or S2. With these taken into account, the lᵣ may be on the order of 50 to 60 mm. Heating elements 24 having a diameter d much greater than this will lead to devices 2 (when considering other practicalities, such as mouthpiece end 26) having an overall size which is greater than the size of a palm of a user. In other implementations, the heating element area may be no greater than 80 mm² or no greater than 75 mm². However, in other implementations, the areal extent of the heating element may be different from that described.

Iri addition, the diameter d of the heating elements may also be set to accommodate a relative increase in mass of the portion of aerosol generating material such that the aerosol generating material may be appropriately heated in the desired time scale to generate aerosol. If, for example, one were to double the thickness tₐ of the aerosol generating material (to double the relative mass), the diameter d scales as the square root of two. Thus, doubling the area of the heating element 24/portion of aerosol generating material 44 does not, lead to a doubling of the diameter.

Thus, a balance between the areal extent of the heating element and the thickness of the aerosol generating portion can be made in order to meet stringent design requirements on the overall size of the device, wherein each portion of aerosol generating material may be heated on at least two separate occasions.

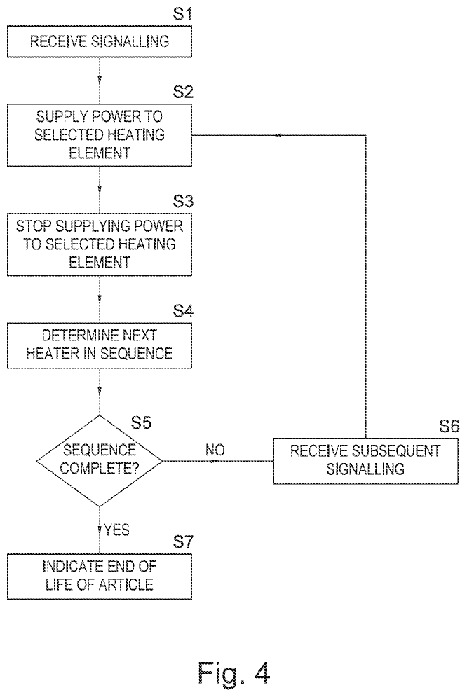

FIG. 4 represents an example method of generating an aerosol using the device 2 as described above and in accordance with the principles of the present disclosure. The method starts at step St where the device 2 receives signaling from either one or both of the touch-sensitive panel 29 and inhalation sensor 30 signifying a user's intention to inhale aerosol, as discussed above. The device 2 may already be in a “stand-by” state prior to step S1 and as such the control circuitry 23 is in a state where it is monitoring for the signaling.

In response to detecting the signaling from either one or both of the touch-sensitive panel 29 and inhalation sensor 30, the control circuitry 23 is configured to supply power to a selected heating element 24 (or more generally is arranged to cause heating of a selected portion of aerosol generating material 44 at the operational temperature) at step S2.

The selected heating element may be selected using a predefined heating sequence.

For example, the heating sequence through which the control circuitry is arranged to raise the temperature of the heating elements to an operational temperature may be: heating element 24a followed by heating element 24b followed by heating element 24c . . . and so on up to heating elerrierii 24f, and then back to heating element 24a followed by heating element 24b . . . and so on up to heating element 24f. According to this sequence, the next heating element in the sequence is never the same as the current heating element in the sequence. Or put another way, the control circuitry 23 is configured to cause sequential heating of each portion of aerosol generating material 44 on one occasion, before causing heating of any given portion of aerosol generating material on a second occasion. This type of sequence may effectively split the inhalation session in to two halves (or multiple sections); a first half where the aerosol is generated from “fresh” aerosol generating material, and a second half where aerosol is generated from “previously used” aerosol generating, material. This may simulate other products where the quality of aerosol may slightly decline towards the end of the session and naturally indicate the onset of the end of the session.

Alternatively, the heating sequence through which the control circuitry is arranged to raise the temperature of the heating elements to an operational temperature may be: heating element 24a and then a second heating of heating element 24a, followed by heating element. 24b and then a second heating of heating element 24b . . . and so on up to heating element 24f, and then a second heating of heating element 24f. According to this sequence, the next heating element in the sequence may be the same as the current heating element in the sequence. Or put another way, the control circuitry 23 is configured to cause heating of a first portion of the aerosol generating material (at least) on two separate occasions before causing heating of a second portion of the aerosol generating material. This type of sequence may effectively alternate the inhalations between aerosol generated from “fresh” aerosol generating material and aerosol generated from “previously used” aerosol generating material. The change in aerosol quality may be less noticeable to a user in this instance for a more consistent overall experience.

The sequences above are exemplary, and it will be apparent to the skilled person that other variations of the heating sequences, including a combination of the two types mentioned above, may he employed in accordance with the principles of the present disclosure.

Once power is supplied to the selected heating element at step S2, at step S3 the control circuitry stops the power supply to the selected heating element. The control circuitry 23 may stop the supply of power based either on a predetermined time from the signaling being detected at step Si elapsing, or based on when the signaling at step St stops being received by the control circuitry 23. In other words, the duration of heating may be set in advance in accordance with the predetermined time or may depend up on the length of the user's puff as detected by the inhalation sensor 30 or based on the length of time the user interacts with the touch-sensitive panel 29. However, in either case the heating duration will broadly correspond to a users puff or a typical puff. Typically the duration of heating will be on the order of 2 to 5 seconds, and in most implementations will be no longer than 10 seconds. In some implementations where the length of heating is based on the user's puff duration, a cut-off may be implemented in which power to the heating elements 24 is stopped after 10 seconds of inhalation to prevent abuse of the system 1. A cut-off my also be implemented to prevent using too much of the aerosol generating material (i.e., generating too much aerosol) such that very little material remains in the portion of the aerosol generation material for the second heating occurrence. Hence, in essence, the control circuitry is configured to heat the one or more heating elements to an operational temperature at which aerosol is generated for no longer than 10 consecutive seconds (where it should be appreciated that the cumulative heating time over two or more heating occurrences may be greater than 10 seconds in some implementations).

At step S4, the control circuitry 23 determines the next heating element in the sequence and sets this as the selected heating element. In this regard, the control circuitry 23 may be configured to store a value in memory (not shown) indicating the position in the sequence, and at step S2, S3, or S4 (i.e., during the current heating phase or after), increment the stored number by one. The control circuitry 23 may also store the sequence in memory.

At step S5, the control circuitry 23 is configured to determine whether the sequence is complete. For example, the control circuitry 23 may not be able to determine a next heating, element in the sequence at step S4, for example. Assuming the sequence has not completed (i.e., a NO at step S5), the method proceeds to step S6 where the control circuitry 23 monitors for, and may subsequently receive, further signaling from either one or both of the touch-sensitive panel 29 and inhalation sensor 30 signifying the user's intention to inhale aerosol. Once the signaling is received, the method proceeds back to step S2 and continues as indicated in FIG. 4. This process is repeated for remaining heating elements 24 in the sequence, provided the user continues to provide the appropriate signaling.

It should be noted that although step S5 is shown in FIG. 4 as distinct from step S4, these steps may be combined or even reversed in accordance with other implementations. The ordering of these steps is not significant to the principles described herein.

If the control circuitry 23 determines that the sequence has completed at step S5 (i.e., a YES at step S5), then the method proceeds to step S7. At step S7, the control circuitry 23 may be configured to generate an alert signal which signifies the end of use of the article 4, for example when the sequence has completed and the heating elements 24 have been activated on at least two separate occasions. With reference to FIG. 1, the device 2 includes an end of use indicator 31 which in this implementation is an LED. However, in other implementations, the end of use indicator 31 may comprise any mechanism which is capable of supplying an alert signal to a user: that is, the end of use indicator 31 may be an optical element to deliver an optical signal, a sound generator to deliver an aural signal, and/or a vibrator to deliver a haptic signal. In some implementations, the indicator 31 may be combined or otherwise provided by the touch-sensitive panel 29 (e.g., if the touch-sensitive panel includes a display element). The device 2 may prevent subsequent activation of the device 2 when the alert signal is being output. The alert signal may be switched off, and the control circuitry 23 reset, when the user replaces the article 4 and/or switches off the alert signal via a manual means such as a button (not shown). The method may then proceed back to step S1, should the user wish to begin another session using a new article 4.

Effectively, the method set out in FIG. 4 means that for each inhalation a different one of the discrete portions of aerosol generating rail terial 44 is heated and an aerosol generated therefrom. Such sequential activations may be dubbed “a sequential activation mode”, which is primarily designed to deliver a consistent aerosol per inhalation (which may be measured in terms of total aerosol generated, or a total constituent delivered, for example).

Although not explicitly stated above, in the described implementation the control circuitry is configured to cause aerosolization of only orie portion of aerosol generating material at any one time.

Although not explicitly described in relation to FIG. 4, in some implementations, the control circuitry 23 may be configured to perform a pre-heat phase prior to beginning step S2 (and potentially also before steps S1 or S6). In other words, before receiving the signaling to begin aerosolization, the control circuitry 23 may already be heating the selected heating element in advance but to a temperature which does not cause substantial aerosolization of the aerosol generation material. The pre-heat temperature may be in the range of 50 to 150° C. and in some implementations is around 100° C. for an amorphous solid, but will vary depending upon the aerosol generating material, In this way, when a signal is received at step S1 or S6, the control circuitry 23 increases the supply of power to the selected heating element at step S2 to increase the temperature of the selected heating element to an operational temperature at which aerosol is generated. As mentioned above, a portion of aerosol generating material designed to be aerosolized on at least two separate occasions may, in some implementations, be relatively thicker than a portion of aerosol generating material designed to be aerosolized on only one occasion. Hence, pre-heating the next heating element/portion of aerosol generating material can help reduce the time required to reach an aerosolization temperature. In this regard, in some instances, two heating elements may be activated simultaneously, one at the operational to and one at the pre-heat temperature. However, in accordance with the above example, only one heating element is controlled to be at the operational temperature (and thus aerosol is only generated from one portion of aerosol generating material at any given moment).

As mentioned, the temperature of the heating element can influence the time between initial heating and aerosol generation as well as the amount of aerosol that is generated. The operational temperature is likely to be different for different aerosol generating materials, and may be determined empirically or via computer simulation for example. However, for most aerosol generating, materials, the operational temperature is no greater than 350° C., or no greater than 320° C., or no greater than 300° C. This is because, at temperatures much beyond these limits, most aerosol generating materials may start to combust or may at least be approaching the temperature of conibustion. Operating at a temperature that is too high is likely to cause charring or burning of the aerosol generating material 44 which may provide unpleasant tastes in the generated aerosol.

### EXAMPLE 1

Two samples of amorphous solid each comprising about 20 wt % alginate gelling agent, about 48 wt % Virginia tobacco extract and about 32 wt % glycerol (DWB), were heated using a circular heating element having a diameter of 12.52 mm. A first sample had a thickness of 0.1 mm and a second sample had a thickness of 0.2 ram.

The heating element temperature was set at 270° C. In this test, the heating element was brought up to temperature, then brought into contact with the amorphous solid, for 5.5 seconds. The aerosol started to be collected after 4 seconds from initial contact of the heating element with the amorphous solid using a simulated puff. On average, the per puff aerosol collected mass (ACM) was found to be around 2.0 mg/puff for the 0.1 m thick amorphous solid and, under the same conditions, was found to be around 2.4 mg/puff for the 0.2 mm thick amorphous solid.

In other words, this example shows that doubling the thickness (and hence mass) for a portion of the amorphous solid provides substantially the same output per puff under broadly the same heating conditions. However, the thicker amorphous solid portion outputs a smaller proportion of the total mass of the amorphous solid as an aerosol during the heating.

Hence, in some implementations of the present disclosure, the thickness of the amorphous solid for providing portions of aerosol generating material which output sufficient aerosol per puff for at least two heating occurrences may have a thickness in the range of 0.05 mm to 2 mm, or in range of 0.1 mm to 1.0 mm. In some implementations, the thickness is greater than 0.1 mm. In other implementations, the thickness is less than 2 mm, or less than 1 mm. Alternatively or additionally, the mass of a portion of aerosol generating material may he no greater than 20 mg, no greater than 10 mg, or no greater than 5 mg.

While the above has described systems in which portions of aerosol generating material 44 are heated sequentially, in other implementations, the control circuitry 23 is configured to supply power to one or more of the heating elements 24 simultaneously. In such implementations, the control circuitry 23 may be configured to supply power to selected ones of the heating elements 24 in response to a predetermined configuration. The predetermined configuration may be a configuration selected or determined by a user. Accordingly, such simultaneous heating element 24 activations may be dubbed “a simultaneous activation mode”, which may primarily be designed to deliver a customizable aerosol from a given article 4, with the intention of allowing a user to customize their experience on a session-by-session or even puff-by-puff basis. Hence, this mode may be most effective when portions of the aerosol generating material 44 of the aerosol generating article 4 are different from one another. For example, portions 44a and 44b are formed of one material, portions 44c and 44d are formed of a different material, etc. Accordingly, with this mode of operation, the user may select which portions to aerosolize at any given moment and thus which combinations of aerosols to be provided with. In accordance with the present disclosure, each portion 44 is provided with a sufficient mass and areal extent such that die portions can be heated on at least two occasions as described above. However, unlike the method in FIG. 4, the control circuitry 23 at step S2 may supply power to all the selected heating, elements according to the configuration described above. At step S3, power may be stopped. S4 may be omitted, and instead the control circuitry 23 determines whether the article 4 is at an end of life, for example by monitoring the number of activations per portion 44. In such implementations, the control circuitry may be configured to blend aerosols generated from simultaneously heating a plurality of aerosols generated from the different portions of aerosol generating material. For example, the control circuitry may be configured to simultaneously heat a portion of aerosol generating material which has yet to be aerosolized on one occasion (i.e., a “fresh” portion of aerosol generating material) and a portion of aerosol generating material which has been aerosolized on one occasion. Operating in this way may enable different tastes or constituents generated on the first and second occurrences of the aerosolization process to be blended thus resulting in a generally consistent experience for the user (except on the first and last inhalations of the article 4).

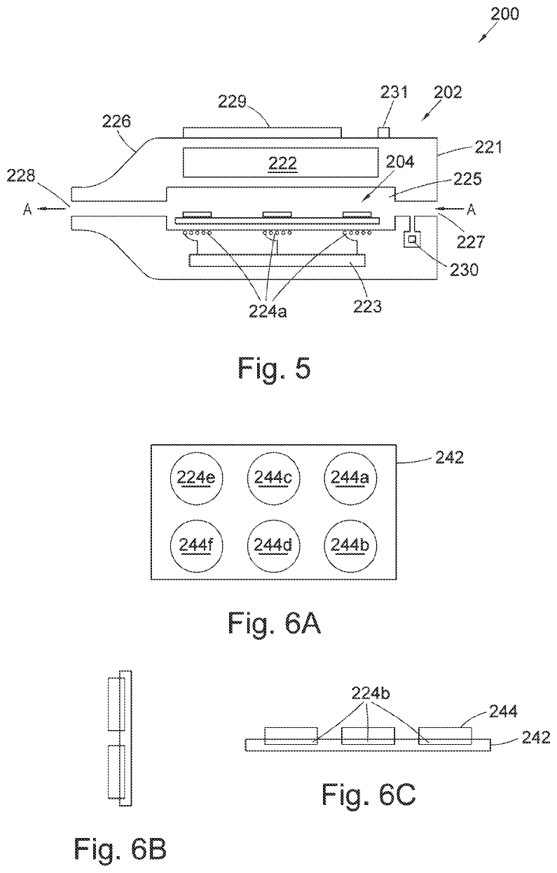

FIG. 5 is a cross-sectional view through a schematic representation of an aerosol provision system 200 in accordance with another embodiment of the disclosure. The aerosol provision system 200 includes components that are broadly similar to those described in relation to FIG. 1; however, the reference numbers have been increased by 200. For efficiency, the components having similar reference numbers should be understood to be broadly the same as their counterparts in FIGS. 1 and 2A to 2C unless otherwise stated.

The aerosol provision device 202 comprises an outer housing 221, a power source 222, control circuitry 223, induction work coils 224a, a receptacle 225, a mouthpiece end 226, an air inlet 227, an air outlet 228, a touch-sensitive panel 229, an inhalation sensor 230, and an end of use indicator 231.

The aerosol generating article 204 comprises a carrier component 242, aerosol generating material 244, and susceptor elements 244b, as shown in more detail in FIGS. 6A to 6C. FIG. 6A is a top-down view of the article 4, FIG. 6B is an end-on view along the longitudinal (length) axis of the article 4, and FIG. 6C is a side-on view along the width axis of the article 4.

FIGS. 5 and 6 represent an aerosol provision system 200 which uses induction to heat the aerosol generality material 244 to generate an aerosol for inhalation.

In the described implementation, the aerosol generating component 224 is formed of two parts namely, induction work coils 224a which are located in the aerosol provision device 202 and susceptors 224b which are located in the aerosol generating article 204. Accordingly, in this described implementation, each aerosol generating component 224 comprises elements that are distributed between the aerosol generating article 204 and the aerosol provision device 202.

Induction heating is a process in which an electrically-conductive object, referred to as a susceptor, is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating.

A susceptor is material that is heatable by penetration with a varying magnetic field, such as an alternating magnetic field. The heating material may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The heating material may be both electrically-conductive and magnetic, so that the heating material is heatable by both heating mechanisms.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating, the object with a varying magnetic field can cause both Joule heating and magnetic hysteresis heating in the object. Moreover, the use of magnetic material can strengthen the magnetic field, which can intensify the Joule heating.

In the described implementation, the susceptors 224b are formed from an aluminum foil, although it should be appreciated that other metallic andior electrically conductive materials may be used in other implementations. As seen in FIG. 6, the carrier component 242 comprises a number of susceptors 224b which correspond in size and location to the discrete portions of aerosol generating material 244 disposed on the surface of the carrier component 242, That is, the susceptors 224b have a similar width and length to the discrete portions of aerosol generating material 244. The susceptors are shown embedded in the carrier component 242. However, in other implementations, the susceptors 224b may be placed on the surface of the carrier component 242.

The aerosol provision device 202 comprises a plurality of induction work coils 224a shown schematically in FIG. 5. The work coils 224a are shown adjacent the receptacle 225, and are generally flat coils arranged such that the rotational axis about which a given coil is wound extends into the receptacle 225 and is broadly perpendicular to the plane of the carrier component 242 of the article 204. The exact windings are not shown in FIG. 5 and it should be appreciated that any suitable induction coil may be used.

The control circuitry 223 comprises a mechanism to generate an alternating current which is passed to any one or more of the induction coils 224a. The alternating current generates an alternating magnetic field, as described above, which in turn causes the corresponding susceptor(s) 224b to heat up. The heat generated by the susceptor(s) 224b is transferred to the portions of aerosol generating material 244 accordingly.

As described above in relation to FIGS. 1 and 2A to 2C, the control circuitry 223 is configured to supply current to the work coils 224a in response to receiving signaling from the touch sensitive panel 229 and/or the inhalation sensor 230. Any of the techniques for selecting which heating elements 24 are heated by control circuitry 23 as described previously may analogously be applied to selecting which work coils 224a are energized (and thus which portions of aerosol generating material 244 are subsequently heated) in response to receiving signaling from the touch sensitive panel 229 and/or the inhalation sensor 230 by control circuitry 223 to generate an aerosol for user inhalation.

Although the above has described an induction heating aerosol provision system where the work coils 224a and susceptors 224b are distributed between the article 204 and device 202, an induction heating aerosol provision system may be provided where the work coils 224a and susceptors 224b are located solely within the device 202. For example, with reference to FIG. 5, the susceptors 224b may be provided above the induction work coils 224a and arranged such that the susceptors 224b contact the lower surface of the carrier component 242 (in an analogous way to the aerosol provision system 1 shown in FIG. 11.

Thus, FIG. 5 describes a more concrete implementation where induction heating may be used in an aerosol provision device 202 to generate aerosol for user inhalation to which the techniques described in the present disclosure may be applied.

Although the above has described a system in which an array of aerosol generating components 24 (e.g., heater elements) are provided to energize the discrete portions of aerosol generating material, in other implementations, the article 4 and/or an aerosol generating component 24 may be configured to move relative to one another. That is, there may be fewer aerosol generating components 24 than discrete portions of aerosol generating material 44 provided on the carrier component 42 of the article 4, such that relative movement of the article 4 and aerosol generating components 24 is required in order to be able to individually energize each of the discrete portions of aerosol generating material 44. For example, a movable heating element 24 may be provided within the receptacle 25 such that the heating element 24 may move relative to the receptacle 25. In this way, the movable heating element 24 can be translated (e.g., in the width and length directions of the carrier component 42) such that the heating element 24 can be aligned with respective ones of the discrete portions of aerosol generating material 44. This approach may reduce the number of aerosol generating components 42 required while still offering a similar user experience.

Although the above has described implementations where discrete, spatially distinct portions of aerosol generating material 44 are deposited on a carrier component 42, it should be appreciated that in other implementations the aerosol generating material may not be provided in discrete, spatially distinct portions but instead be provided as a continuous sheet of aerosol generating material 44. In these implementations, certain regions of the sheet of aerosol generating material 44 may be selectively heated to generate aerosol in broadly the same manner as described above. However, regardless of whether or not the portions are spatially distinct, the present disclosure described heating (or otherwise aerosolizing) portions of aerosol generating material 44. In particular, a region ((corresponding to a portion of aerosol generating material) may be defined on the continuous sheet of aerosol generating material based on the dimensions of the heating element 24 (or more specifically a surface of the heating element 24 designed to increase in temperature). In this regard, the corresponding area of the heating element 24 when projected onto the sheet of aerosol generating material may be considered to define a region or portion of aerosol generating material. In accordance with the present disclosure, each region or portion of aerosol generating material may have a mass no greater than 20 mg, however the total continuous sheet may have a mass which is greater than 20 mg,. Although the above has described implementations where the device 2 can be configured or operated using the touch-sensitive panel 29 mounted on the device 2, the device 2 may instead be configured or controlled remotely. For example, the control circuitry 23 may be provided with a corresponding communication circuitry (e.g., Bluetooth) which enables the control circuitry 23 to communicate with a remote device such as a smartphone. Accordingly, the touch-sensitive panel 29 may, in effect, be implemented using an App or the like running on the smartphone. The smartphone may then transmit user inputs or configurations to the control circuitry 23, and the control circuitry 23 may be configured to operate on the basis of the received inputs or configurations.

Although the above has described implementations in which an aerosol is generated by energizing (e.g., heating) aerosol generating, material 44 which is subsequently inhaled by a user, it should be appreciated in some implementations that the generated aerosol may be passed through or over an aerosol modifying component to modify one or more properties of the aerosol before being inhaled by a user. For example, the aerosol provision device 2, 202 may comprise an air permeable insert (not shown) which is inserted in the airflow path downstream of the aerosol generating material 44 (for example, the insert may be positioned in the outlet 28). The insert may include a material which alters any one or more of the flavor, temperature, particle size, nicotine concentration, etc. of the aerosol as it passes through the insert before entering the user's mouth. For example, the insert may include tobacco or treated tobacco. Such systems may be referred to as hybrid systems. The insert may include any suitable aerosol modifying material, which may encompass the aerosol generating materials described above.

Although it has been described above that the heating elements 24 are arranged to provide heat to a portion of aerosol generating material at an operational temperature at which aerosol is generated from the portion (if aerosol generating, material, in some implementations, the heating elements 24 are arranged to pre-heat portions of the aerosol generating material to a pre-heat temperature (which is lower than the operational temperature). At the pre-heat temperature, a lower amount or no aerosol is generated when the portion is heated at the pre-heat temperature. However, a lower amount of energy is required to raise the temperature of the aerosol generating material from the pre-heat temperature to the operational temperature. This may be particular suitable for relatively thicker portions of aerosol generating material, e.g., having thicknesses above 400 pm, which require relatively larger amounts of energy to be supplied in order to reach the operational temperature. In such implementations, the energy consumption (e.g., from the power source 22) may be comparably higher, however.

Although the above has described implementations in which the aerosol provision device 2 comprises an end of use indicator 31, it should be appreciated that the end of use indicator 31 may be provided by another device remote from the aerosol provision device 2. For example, in some implementations, the control circuitry 23 of the aerosol provision device 2 may comprise a communication mechanism which allows data transfer between the aerosol provision device 2 and a remote device such as a sraariphone or smart watch, for example. In these implementations, when the control circuitry 23 determines that the article 4 has reached its end of use, the control circuitry 23 is configured to transmit a signal to the remote device, and the remote device is configured to generate the alert signal (e.g., using the display of a smartphone). Other remote devices and other mechanisms for generating the alert signal may be used as described above.

In some implementations, the article 4 may comprise an identifier, such as a readable bar code or an RI-4D tag or the like, and the aerosol provision device 2 comprises a corresponding reader. When the article is inserted into the receptacle 25 of the device 2, the device 2 may be configured to read the identifier on the article 4. The control circuitry 23 may be configured to either recognize the presence of the article 4 (and thus permit heating andior reset an end of life indicator) or identify the type and/or the location of the portions of the aerosol generating material relative to the article 4. This may affect which portions the control circuitry 23 aerosolizes and/or the way in which the portions are aerosolized, e.g., via adjusting the aerosol generation temperature and/or heating duration. Any suitable technique for recognizing the article 4 may be employed.

In addition, when the portions of aerosol generating material are provided on a carrier component 42, the portions may, in some implementations, include weakened regions, e.g., through holes or areas of relatively thinner aerosol generating material, in a direction approximately perpendicular to the plane of the carrier component 42. This may be the case when the hottest pan of the aerosol generating material is the arca directly contacting the carrier component (in other words, in scenarios where the heat is applied primarily to the surface of the aerosol generating material that contacts the carrier component 42). Accordingly, the through holes may provide channels for the gene rated. aerosol to escape and be released. to the environment/the air flow through the device 2 rather than causing a potential build-up of aerosol between the carrier component 42 and the aerosol generating material 44. Such build-up of aerosol can reduce the heating efficiency of the system as the build-up of aerosol can, in some implementations, cause a lifting of the aerosol generating material from the carrier component 42 thus decreasing the efficiency of the heat transfer to the aerosol generating material. Each portion of aerosol generating material may be provided with one of more weakened regions as appropriate.

Thus, there has been described an aerosol provision device for use with an aerosol generating article comprising aerosol generating material. The aerosol provision device comprises one or more aerosol generating components arranged to aerosolize different portions of the aerosol generating material, and control circuitry for supplying power to the one or more aerosol generating components. The control circuitry is configured to perform an aerosolization process on a first portion of the aerosol generating material on at least two separate occasions. Accordingly, aerosol can be generated for user inhalation on at least two separate occasions from the same portion of aerosol generating material, thus permitting greater spatial efficiency. Also described is an aerosol provision system, an aerosol generating article, and a method for generating aerosol.

While the above described embodiments have in some respects focused on some specific example aerosol provision systems, it will be appreciated the same principles can be applied for aerosol provision systems using other technologies. That is to say, the specific manner in which various aspects of the aerosol provision system function are not dire cdy relevant to the principles underlying the examples described herein.

In order to address various issues and advance die art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the claims, Various embodiments may suitably comprise, consist of, or consist essentially of, various combinations of the disclosed elements, components, features, parts, steps, means, etc. other than those specifically described herein, and it will thus be appreciated. that features of the dependent claims may be combined with features of the independent claims in combinations other than those explicitly set out in the claims, The disclosure may include other inventions not presently claimed, but which may be claimed in future.

1. An aerosol provision device for use with an aerosol generating article comprising aerosol generating material, the aerosol provision device comprising:
one or more aerosol generating components arranged to aerosolize different portions of the aerosol generating material; and
control circuitry for supplying power to the one or more aerosol generating components, wherein the control circuitry is configured to perform an aerosolization process on a first portion of the aerosol generating material on at least two separate occasions.

2. The aerosol provision device of claim 1, wherein the control circuitry is configured to cause aerosolization of one portion of aerosol generating material at any one time.

3. The aerosol provision device of claim 1, wherein the control circuitry is configured to perform an aerosolization process on the first portion of aerosol generating material on two separate occasions.

4. The aerosol provision device of claim 1, wherein the one or more aerosol generating components are heating elements.

5. The aerosol provision device of claim 4, wherein the control circuitry is configured to cause heating of a first portion of the aerosol generating material at least on two separate occasions before causing heating of a second portion of the aerosol generating material.

6. The aerosol provision device of claim 4, wherein the control circuitry is configured to cause sequential heating of each portion of aerosol generating material on one occasion, before causing heating of the first portion of aerosol generating material on a second occasion.

7. The aerosol provision device of claim 4, wherein the control circuitry is configured to receive a signal signifying a user's intent to generate aerosol, and in response to receiving the signal, cause heating of a portion of the aerosol generating material.

8. The aerosol provision device of claim 4, wherein the control circuitry is configured to heat the one or more heating elements to a temperature no greater than 350° C.

9. The aerosol provision device of claim 4, wherein the control circuitry is configured to heat the one or more heating elements to an operational temperature at which aerosol is generated for no longer than 10 consecutive seconds.

10. The aerosol provision device of claim 4, wherein each heating element has an areal extent no greater than 130 mm².

11. An aerosol provision system for generating aerosol from an aerosol generating material, wherein the system comprises: an aerosol generating article comprising a plurality of portions of aerosol generating material; one or more aerosol generating components arranged to aerosolize different portions of the aerosol generating material; and control circuitry for supplying power to the one or more aerosol generating components, wherein the control circuitry is configured to perform an aerosolization process on a first portion of the aerosol generating material on at least two separate occasions.

12. The aerosol provision system of claim 11, wherein the control circuitry is configured to cause aerosolization of one portion of aerosol generating material at any one time.

13. The aerosol provision system of claim 11, wherein the control circuitry is configured to perform an aerosolization process on the first portion of aerosol generating material on two separate occasions.

14. The aerosol provision device of claim 11, wherein the one or more aerosol generating components are heating elements having an areal extent no greater than 130 mm².

15. The aerosol provision system of claim 14, wherein the control circuitry is configured to cause heating of a first portion of the aerosol generating material at least on two separate occasions before causing heating of a second portion of the aerosol generating material.

16. The aerosol provision system of claim 14, wherein the control circuitry is configured to cause sequential heating of each portion of aerosol generating material on one occasion, before causing heating of the first portion of aerosol generating material on a second occasion.

17. The aerosol provision device of claim 15, wherein the control circuitry is configured receive a signal signifying a user's intent to generate aerosol, and in response to receiving the signal, cause heating of a portion of the aerosol generating material.

18. The aerosol provision device of claim 14, wherein the control circuitry is configured to heat the one or more heating elements to a temperature no greater than 350° C. and for no longer than 10 consecutive seconds.

19-20. (canceled)

21. The aerosol provision device of claim 11, wherein the aerosol generating material is an amorphous solid having a thickness in a range of 0.05 mm to 2 mm.

22. (canceled)

23. An aerosol generating article comprising a plurality of portions of aerosol generating material, wherein each of the plurality of portions of aerosol generating material has a thickness of between 0.05 mm to 2 mm.

24-25. (canceled)
